(19) United States
(12) Patent Application Publication
(10) Pub. No.: US 2002/0138690 A1
(43) Pub. Date: Sep. 26, 2002

(54) System and method for performing a partial DRAM refresh

(76) Inventors: Stephen M. Simmonds, San Diego, CA (US); Jalal El Husseini, San Diego, CA (US); Haitao Zhang, San Diego, CA (US); Qiuzhen Zou, San Diego, CA (US)

Correspondence Address: Qualcomm Incorporated, Patents Department, 5775 Morehouse Drive, San Diego, CA, 92121-1714, US

(21) Appl. No.: 09/815,516

(22) Filed: Mar. 23, 2001

(51) Int. Cl. G06F 12/00

(52) U.S. Cl. 711/106

(57) ABSTRACT

A system and method for performing a partial refresh of memory cells within a memory drive. The selection of rows to be refreshed is based on an algorithm. Each selected row of memory cells is compared to an indicator chosen by a manufacturer, user, or software internal to an electrical device. Depending on this comparison, the next row to be refreshed may be, but is not limited to, a row based on the algorithm or a first row in the DRAM array.

### BACKGROUND OF THE INVENTION

1. Field of the Invention

This invention generally relates to Dynamic Random Access Memory (DRAM). More particularly, the invention is directed to a system and method for refreshing DRAMs whereby their power consumption is reduced.

2. Description of the Related Art

Many electrical devices use memory, for example, random-access-memory (“RAM”) for the on-board storage of data. RAM may be written to and read from, and will maintain its contents until power is interrupted to the memory location. Often, a battery complements the use of static random-access memory (“SRAM”) in an electrical device to ensure that the SRAM maintains its contents even when the electrical device is in an off mode, thereby overcoming the memory's inherent volatility. Dynamic random-access memory (“DRAM”), like many memory devices, is comprised of cells arranged in an array of columns and rows. DRAM, unlike SRAM, requires a smaller physical memory location in the electrical device and thus offers increased capacity over SRAM. However, DRAM requires the contents of its cells to be refreshed every few milliseconds.

DRAM cells require this periodic refresh to restore their charge as their charge leaks away over time. One method of refreshing a DRAM is called Row Address Strobe (RAS) only refresh and is performed row by row in the array. Once the row address and strobing RAS are provided, all of the memory cells in the row are refreshed in parallel. This method will complete a refresh of the entire device in as many cycles as there are rows. No column address strobe (CAS) signal is necessary to perform this method of refresh.

A second method of refreshing a DRAM is to perform a self-refresh. This method uses an internal refresh counter to generate the refresh address to the array. Specifically, a CAS signal is asserted before the RAS signal to initiate the self-refresh cycle. As with the RAS only refresh, each time the internal refresh counter is activated; one row in the DRAM array is refreshed. Using this method, the entire DRAM array must be refreshed by way of multiple activations of the internal refresh counter.

Another technique for refreshing a DRAM allows a specific row to be refreshed by performing a dummy read to that row. However, this method requires activation of several of the DRAM chip address pins.

These conventional techniques will efficiently prevent the gradual loss of data in cases where the entire memory is being used; however, this efficiency is lost when less than the entire memory is being utilized. These conventional techniques do not discriminate between memory rows that are and are not being used by the electrical device to store data or information. Regardless of whether data is being stored, a refresh is performed to each row. This perpetual refresh increases the rate of power drain from the electrical device and thus will shorten the time between recharge cycles. For some users, these shorter recharge cycles present a significant burden as our society shifts to the use of mobile technologies.

Thus, there is a need for a system and method for refreshing a portion of cells in a DRAM chip without having to perform multiple activations to the entire DRAM array. Such a system and method would take into account the portion of the DRAM array that is being used by the electrical device to store data or information. Moreover, the system and method would allow the user to select the portion of cells in the DRAM chip that are refreshed. Furthermore, this system and method would preferably minimize activations of the DRAM chip address pins.

### SUMMARY OF THE INVENTION

The systems and methods of the invention have several features, no single one of which is solely responsible for its desirable attributes. Without limiting the scope of this invention as expressed by the claims which follow, its more prominent features will now be discussed briefly. After considering this discussion, and particularly after reading the section entitled “Detailed Description of the Invention” one will understand how the features of this invention provide several advantages over traditional programming of electrical devices.

One aspect of the invention is a method of refreshing a memory device having an array of addressable rows and columns of memory cells. The method comprises initiating a partial refresh of a first row in the memory device based on an algorithm. The method further comprises comparing the selected row to an indicator. Finally, a second row is selected for the partial refresh based on the comparison.

Another aspect of the invention is a system for refreshing a random access memory device. The system comprises an array of addressable rows and columns of memory cells, an internal counter circuit that identifies which portion of the addressable rows of memory cells are to be refreshed, and an external reset circuit coupled to the internal counter circuit such that the external reset circuit resets the internal counter circuit depending on the memory requirements of the random access memory device.

### BRIEF DESCRIPTION OF THE DRAWINGS

FIG. 1 is a block diagram illustrating a macro on a DRAM chip as used in an electrical device according to one embodiment of the invention.

FIG. 2 is a flow chart illustrating one embodiment of a refresh process that is performed by the electrical device shown in FIG. 1.

### DETAILED DESCRIPTION OF THE INVENTION

The following detailed description is directed to certain specific embodiments of the invention. However, the invention can be embodied in a multitude of different ways as defined and covered by the claims. In this description, reference is made to the drawings wherein like parts are designated with like numerals throughout.

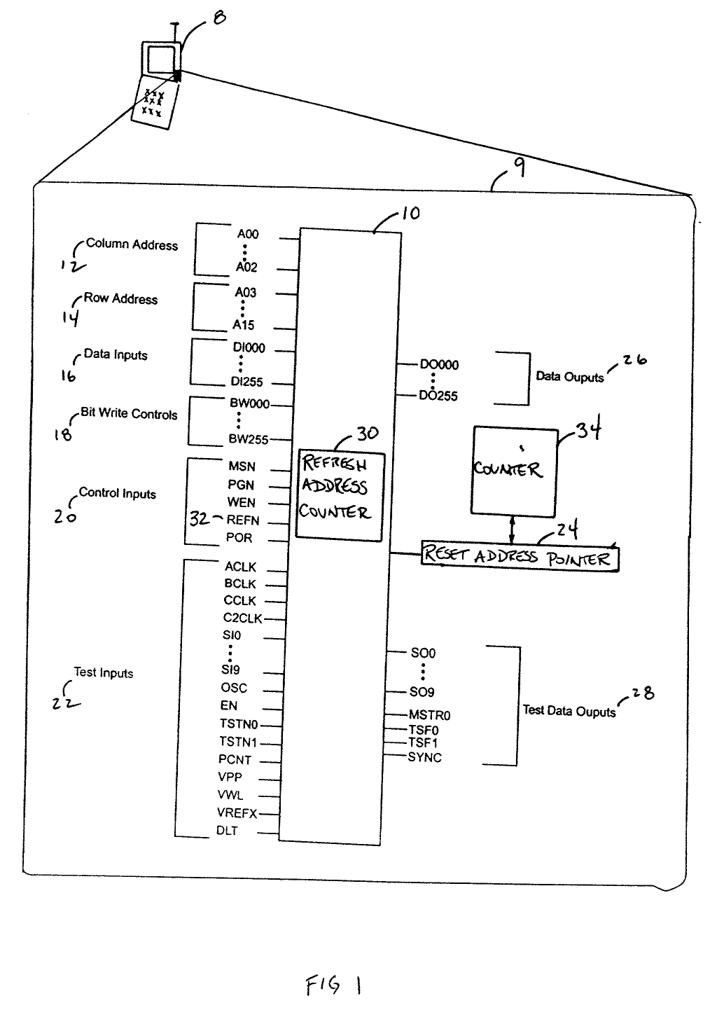

FIG. 1 is a representative diagram of an electrical device 8 incorporating a DRAM chip 9 in accordance with the invention. FIG. 1 illustrates a macro 10 located on the DRAM chip 9. While the design of the DRAM chip includes numerous aspects, the invention here disclosed is focussed on the refresh process. However, one who is skilled in the art will appreciate that the following invention is not limited to the embodiment illustrated in FIG. 1 and may be utilized in conjunction with other DRAM chips not here disclosed.

The electrical device 8 may be, for example, a cellular phone, a Personal Data Assistant (PDA), a computer, other electrical devices that incorporate memory, or a permutation of these devices. For example, the computer may be a desktop, server, portable, hand-held, set-top, computer network, or any other desired type of configuration. The DRAM chip 9 may be used in conjunction with various operating systems such as: UNIX, LINUX, Disk Operating System (DOS), Microsoft® Windows® 3.X, Microsoft® Windows® 95, Microsoft® Windows® 98, Microsoft® Windows® NT, Microsoft® Windows® 2000, Microsoft® Windows® Me, Apple® MacOS®, or IBM® OS/2®. The electrical device 8 may use one or more microprocessors, such as a Pentium® processor, a Pentium® II processor, a Pentium® Pro processor, an xx86 processor, an 8051 processor, a MIPS® processor, a Power PC® processor, or an ALPHA® processor. In addition, the microprocessor may be any conventional special purpose microprocessor such as a digital signal processor or a graphics processor.

Still referring to FIG. 1, the inputs to the macro 10 include column address pins 12, row address pins 14, bit write control pins 18, control input pins 20, test input pins 22, and a reset address pointer pin 24. Particular attention for purposes of this invention is drawn to a refresh enable pin (REFN) 32 which is one of the control input pins 20. Activation of the refresh enable pin 32 initiates a refresh cycle to the DRAM chip 9.

Internal to the macro 10 and in electrical communication with the refresh enable pin 32 is a refresh address counter 30. The refresh address counter 30 determines what rows are to be refreshed when a refresh cycle is initiated by the refresh enable pin 32. After each pulse from the refresh enable pin 32, the refresh address counter 30 selects the next row to be refreshed based on an algorithm. The algorithm is, for example, N+1, N+2, N−1, or such other algorithm that specifies a next row for refresh from the DRAM chip 9. In one embodiment, the algorithm selects a range of row numbers to be refreshed. For ease of explanation, the following discussion will assume the algorithm is N+1 whereby the next row selected by the refresh address counter 30 is the current row plus one. Thus, in this embodiment, the refresh address counter 30 increments up by one row in anticipation of a subsequent refresh cycle being initiated by the refresh enable pin 32.

This incremental change to the refresh address counter 30 is performed internally to the macro 10. However, this incremental change is independent of the memory requirements of the electrical device 8 incorporating the DRAM chip 9. For example, if the DRAM chip 9 included 4,096 rows of memory cells in its array, 4,096 separate signals to the refresh enable pin 32 would be required to refresh the entire DRAM chip 9. This number of signals is independent of the number of rows in the DRAM chip 9 that are needed by the electrical device 8. Thus, without further control of the address 30, unnecessary refreshes are performed to rows that are not being used by the electrical device 8. Moreover, these unnecessary refresh cycles consume additional energy from the electrical device 8.

To minimize unnecessary refresh cycles, the macro 10 further includes a reset address pointer pin 24 which is in electrical communication with the refresh address counter 30. The reset address pointer pin 24 allows the refresh address counter 30 to be externally monitored to the macro 10. A counter 34, in communication with the reset address pointer pin 24, is provided to monitor the value of the refresh address counter 30. In one embodiment, the counter 34 is located external to the DRAM chip 9. In an alternate embodiment, the counter 34 is located internal to the DRAM chip 9. In still another embodiment, the counter 34 is located internal to the macro 10.

The counter 34 is programmed with an indicator. The indicator is, for example, a flag, value, or number. In one embodiment, the indicator is a maximum row number. In another embodiment, the indicator corresponds to a total number of rows in the DRAM chip 9 that are to be refreshed. In another embodiment, the indicator corresponds to a specific row number. In another embodiment, the indicator corresponds to a range of row numbers. In still another embodiment, the indicator is selected from between a minimum and a maximum number of rows. In one embodiment, the algorithm mentioned above generates the indicator. In still another embodiment, a software program based on, for example, the memory requirements of the electrical device 8, generates the indicator. Thus, the algorithm operates in concert with the indicator during a refresh of the DRAM chip 9.

In one embodiment, the indicator is stored independent of the counter 34 in a memory device (not shown). However, the storage location of the indicator is accessible by the counter 34. In one embodiment, the manufacturer programs the indicator into the electrical device 8. In another embodiment, the user programs the indicator. In still another embodiment, the indicator is determined by software (not shown) contained within the electrical device 8 based on what portion of the DRAM array is being utilized. Some factors involved in selecting the indicator include determining how many rows of data should be maintained by selecting a continual refresh of those cells as opposed to allowing the data to dissipate to save energy in the electrical device 8. Examples of types of data in a cellular telephone which may be important to a user and thus warrant a continual refresh include what part of town the user was in most recently, whether to maintain the signal between the handset and communication system, and any scratch calculations that are repeatedly performed by the electrical device 8.

Once the indicator is programmed into the electrical device 8, the counter 34 monitors the refresh address counter 30 as it changes after each signal to the REFN 32. Once the value of the indicator is reached by the refresh address counter 30, a reset signal is initiated by the counter 34 to the reset address pointer pin 24 wherein the refresh address counter 30 is reset to a different value, for example, 0. In one embodiment, a controller (not shown) initiates the reset signal once the indicator is reached by the algorithm in the refresh address counter 30. The counter 34 sets the value of the refresh address counter 30 to, for example, a range from zero to forty which limits the subsequent refresh cycle to rows zero through forty of the DRAM array. In one embodiment, when the electrical device 8 is awake or in full power mode, the rows of the DRAM array which are outside of the region specified by the reset address pointer pin 24 are not refreshed, thereby reducing the energy consumption of the DRAM chip 9. Thus, the data stored in the DRAM chip 9 region outside of the refreshed region is allowed to discharge and decay.

The energy savings associated with performing a partial refresh, during the awake or full power mode, as opposed to a complete refresh of the DRAM chip 9 array as described above is further increased when the electrical device 8 is in a sleep or low power mode. In one embodiment, the partial DRAM refresh only occurs while the electrical device 8 is in a sleep or low power mode and not when it is in an awake or full power mode. In sleep or low power modes the electrical device 8 may use only a fraction of the rows available for storage within the DRAM chip 9 as compared to when the electrical device is awake or in full power mode. In the sleep or low power modes, the counter 34 limits the algorithm to refresh the few rows of the DRAM array that are selected. Thus, in low power modes and assuming the algorithm is N+1, the attempted automatic incremental change by the refresh enable pin 32 to the refresh address counter 30 beyond the indicator set by the counter 34 is ineffective.

As described above, during a subsequent cycle the counter 34 monitors the refresh address counter 30 to ensure the selected indicator for the number of rows in the DRAM chip 9 is not exceeded. In one embodiment, the electrical device 8 determines what portion of the rows in the DRAM chip 9 are continually refreshed based on similar factors as described above. If additional memory capacity is required by the electrical device 8, the indicator in the counter 34 is reset to allow the refresh address counter 30 to refresh rows beyond the indicator. During the subsequent cycle, the electrical device 8 resets the counter 34 to an indicator that will refresh the portion of the DRAM chip 9 array that will maintain sufficient memory for the operation of the electrical device 8. Finally, the outputs from the macro 10 include data output pins 26 and test data output pins 28 as shown in FIG. 1.

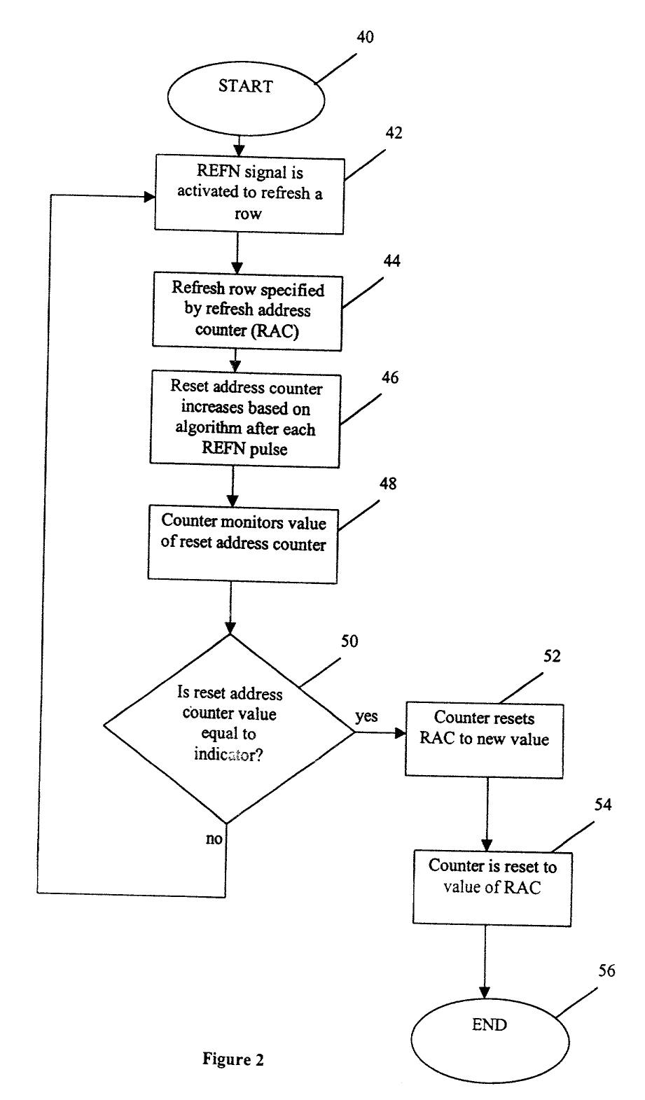

Operation of the DRAM chip 9 in accordance with one embodiment of the invention is described below with reference to FIG. 2. As explained above, the following description assumes the refresh address counter 30 algorithm is N+1. For convenience of description, the following text describes a refresh process with reference to a cellular telephone. However, the refresh process can be used whenever an electrical device incorporates a memory device that requires its cells to be periodically refreshed.

In particular, flow begins in start block 40. Flow proceeds to block 42 where the refresh enable pin (REFN) 32 is activated to initiate a refresh of a row of the DRAM chip 9. Flow continues to block 44 where the row that is currently being pointed to by the refresh address counter 30 is refreshed. Next at a block 46, the refresh address counter 30 is changed incrementally increased based on the algorithm. Moving to block 48, the counter 34 reads the value of the refresh address counter 30 algorithm through the reset address pointer (RAP) pin 24. Flow continues to decision block 50 where the value of the reset address counter 30 algorithm is compared to an indicator that is programmed in the counter 34. In embodiments, the user or the manufacturer selects the indicator. In one embodiment, the electrical device 8 includes software that generates the indicator. If the refresh address counter 30 value is equal to the counter 34 indicator, flow proceeds to block 52 where a signal is sent through the reset address pointer pin 24 to the refresh address counter 30 to reset the refresh address counter 30 to a new value, for example, 0. This resetting of the refresh address counter 30 is accomplished without activating the entire address bus. Flow then proceeds to block 54 where the counter 34 is reset to the new indicator of the refresh address counter 30. Next, at a block 56, the refresh process terminates. Now returning to decision block 50, if the refresh address counter 30 is less than the indicator of the counter 34, the refresh process returns to block 42 and proceeds as described above.

Accordingly, the invention overcomes the longstanding problem of performing unnecessary refresh cycles to rows of unused volatile memory cells by providing a system and method that discriminates between such rows thereby minimizing unnecessary current drain from the electrical device 8.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. The scope of the invention is indicated by the appended claims rather than by the foregoing description. All changes which come within the meaning and range of equivalency of the claims are to be embraced within their scope.

What is claimed is:

1. A method of refreshing a memory device having an array of addressable rows and columns of memory cells, the method comprising the steps of:
initiating a refresh of said memory device;
selecting at least one row of memory cells to be refreshed based on an algorithm;
comparing the selected row to an indicator; and
refreshing said at least one row based on said comparison.

2. The method of claim 1, wherein said step of comparing the selected row is performed for a plurality of rows, each taken in sequential order.

3. The method of claim 1, wherein said algorithm corresponds to a plurality of row numbers, and wherein said plurality of row numbers are refreshed.

4. The method of claim 1, wherein said algorithm corresponds to a range of row numbers, and wherein said range of row numbers are refreshed.

5. The method of claim 4, wherein said range is between a minimum and a maximum number of rows.

6. The method of claim 1, wherein said indicator corresponds to a specific row number.

7. The method of claim 6, wherein said row number is less than said number of rows.

8. The method of claim 6, wherein said row number is a maximum row value.

9. The method of claim 6, wherein said memory device is utilized in an electrical device.

10. The method of claim 9, wherein said indicator is selected by a manufacturer of said electrical device.

11. The method of claim 9, wherein said indicator is selected by a user of said electrical device.

12. The method of claim 1, wherein said algorithm defines rows of memory cells to be refreshed.

13. The method of claim 12, wherein said algorithm is X=N+1, and wherein X is the next row of memory cells to be refreshed and N is the prior row of memory cells that were refreshed.

14. A method of refreshing a memory device having an array of addressable rows and columns of memory cells, the method comprising the steps of:
coupling a reset signal from a source to an internal counter in said memory device, wherein said internal counter selects one of said rows of memory cells based on an algorithm;
initiating a partial refresh of said memory device based on said algorithm, so as to refresh said selected row of memory cells;
comparing a value of said internal counter to an indicator;
changing said internal counter value;
repeating the arts of initiating, comparing and changing until said internal counter value corresponds to said indicator; and
resetting said internal counter based on said indicator.

15. The method of claim 14, wherein said algorithm corresponds to a plurality of row numbers, and wherein said plurality of row numbers are refreshed.

16. The method of claim 14, wherein said algorithm corresponds to a range of row numbers, and wherein said range of row numbers are refreshed.

17. The method of claim 16, wherein said range is between a minimum and a maximum number of rows.

18. The method of claim 14, wherein said indicator corresponds to a row number.

19. The method of claim 18, wherein said row number is a maximum row value.

20. The method of claim 18, wherein said row number is less than said number of rows.

21. The method of claim 14, wherein said step of initiating said partial refresh is performed by transmission of a signal via a refresh enable pin coupled to said memory device.

22. The method of claim 14, wherein said step of resetting said internal counter is initiated in response to said reset signal from said source.

23. The method of claim 14, wherein said source is located external to said memory device.

24. The method of claim 14, wherein said source is located internal to said memory device.

25. The method of claim 14, wherein said memory device is a Random Access Memory.

26. The method of claim 14, wherein said memory device is a Dynamic Random Access Memory.

27. The method of claim 14, wherein said Dynamic Random Access Memory includes 4,096 rows of memory cells.

28. The method of claim 14, wherein said memory device is utilized in an electrical device.

29. The method of claim 28, wherein said indicator is selected by a manufacturer of said electrical device.

30. The method of claim 28, wherein said indicator is selected by a user of said electrical device.

31. The method of claim 28, wherein said electrical device is a cellular telephone.

32. The method of claim 28, wherein said electrical device is in an awake mode.

33. The method of claim 28, wherein said electrical device is in a sleep mode.

34. The method of claim 28, wherein said indicator is selected by software in said electrical device.

35. The method of claim 33, wherein said indicator is dynamically selected based on the required memory of said electrical device.

36. A random access memory device comprising:
an array of addressable rows and columns of memory cells;
an internal counter circuit that identifies which portion of said addressable rows of memory cells are to be refreshed; and
an external reset circuit coupled to said internal counter circuit such that said external reset circuit resets said internal counter circuit depending on memory requirements of said random access memory device.

37. The random access device of claim 36, wherein said external reset circuit resets said internal counter circuit by way of a signal pin connected to said random access memory device.

38. The random access device of claim 36, wherein said random access memory device is a Dynamic Random Access Memory.

39. The random access device of claim 38, wherein said Dynamic Random Access Memory includes 4,096 rows of memory cells.

40. The random access device of claim 36, wherein said memory device is utilized in an electrical device.

41. The random access device of claim 40, wherein said electrical device is a cellular telephone.

42. The random access device of claim 40, wherein said memory requirements are selected by a user of said electrical device.

43. The random access device of claim 40, wherein said memory requirements are selected by a manufacturer of said electrical device.

44. The random access device of claim 40, wherein said memory requirements are selected by software in said electrical device.

45. A system for refreshing a memory device having an array of addressable rows and columns of memory cells, the system comprising:
means for coupling a reset signal from a source to an internal counter in said memory device, wherein said internal counter selects one of said rows of memory cells based on an algorithm;
means for initiating a partial refresh of said memory device based on said algorithm, so as to refresh said selected row of memory cells;
means for comparing a value of said internal counter to an indicator;
means for changing said internal counter value;
means for repeating the arts of initiating, comparing and changing until said internal counter value corresponds to said indicator; and
means for resetting said internal counter based on said indicator.
